(19) United States
(12) Patent Application Publication
(10) Pub. No.: US 2016/0056681 A1
(43) Pub. Date: Feb. 25, 2016

(54) INTEGRATED MOTOR AND CONTROLLER WITH INTERNAL HEAT SINK AND SNAP-ON DRIPSHIELD

(71) Applicant: Nidec Motor Corporation, St. Louis, MO (US)

(72) Inventors: Michael W. Major, Moro, IL (US); Carolyn S. Schaefer, Arlington Heights, IL (US); Gregory A. Peterson, South Barrington, IL (US)

(73) Assignee: NIDEC MOTOR CORPORATION, St. Louis, MO (US)

(21) Appl. No.: 14/465,657

(22) Filed: Aug. 21, 2014

(51) Int. Cl. H02K 5/18; H02K 9/00; H02K 5/10; H02K 5/22

(52) U.S. Cl. CPC H02K 5/18; H02K 5/22; H02K 9/00; H02K 5/10

(57) ABSTRACT

An electric motor includes a stator, a rotor rotatable relative to the stator about a rotor axis, a motor case, and a motor controller. The motor case presents a motor chamber in which the stator is located. The motor controller is supported relative to the motor case and includes a heat-producing component external of the motor chamber. A heat sink is thermally coupled with the heat-producing component of the motor controller and is located within the motor chamber. A dripshield cooperates with the motor case to define a controller chamber in which the controller is at least substantially located. The dripshield and motor case present complementary pairs of latch components, with each pair of latch components including a dripshield latch component and a case latch component. Each pair of latch components is automatically interlocked to secure the dripshield on the motor case.

### BACKGROUND OF THE INVENTION

1. Field of the Invention

The present invention relates generally to electric motors, especially electric motors for use in applications in which space constraints and protection from environmental contaminants are important (e.g., in horizontal axis washing machines). More particularly, the present invention preferably concerns a motor having an integrated controller, a heat sink that is located within the motor chamber and thermally coupled with a heat-producing component of the controller, and a snap-on dripshield.

2. Discussion of the Prior Art

Efficient dissipation of heat generated by motor controllers is necessary in many motor applications. In conventional motors, such dissipation is typically by means of a heatsink mounted external to the motor case and presenting a large surface area (e.g., the surface area provided by a plurality of fins) across which convective currents may flow to transfer heat away from the motor.

Protection of the motor controller from environmental contaminants such as condensation is also necessary in many motor applications. Such protection may suitably by means of a dripshield including a baffle or other structure for deflecting contaminants.

### SUMMARY

According to one aspect of the present invention, an electric motor is provided. The motor comprises a stator, a rotor, a motor case, a motor controller, and a heat sink The rotor is rotatable relative to the stator about a rotor axis. The motor case presents a motor chamber in which the stator is located. The motor controller is supported relative to the motor case, with the motor controller including a heat-producing component external of the motor chamber. The heat sink is thermally coupled with the heat-producing component of the motor controller. The heat sink is located within the motor chamber.

According to another aspect of the present invention, an electric motor is provided. The motor comprises a stator, a rotor, a motor case, a motor controller, and a snap-on dripshield. The rotor is rotatable relative to the stator about a rotor axis. The motor case presents a motor chamber in which the stator is located. The motor controller is located external of the motor chamber. The snap-on dripshield cooperates with the motor case to define a controller chamber in which the controller is at least substantially located. The dripshield and motor case present complementary pairs of latch components, with each pair of latch components including a dripshield latch component and a case latch component. Each pair of latch components is automatically interlocked to secure the dripshield on the motor case.

This summary is provided to introduce a selection of concepts in a simplified form. These concepts are further described below in the detailed description of the preferred embodiments.

This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a front perspective view of a motor constructed in accordance with a first preferred embodiment of the present invention;

FIG. 2 is a rear perspective view of the motor of FIG. 1;

FIG. 3 is a rear view of the motor of FIGS. 1 and 2;

FIG. 4 is a cross-sectional side view of the motor of FIGS. 1-4, taken along line 4-4 of FIG. 3;

FIG. 4a is an enlarged, partially sectioned view of a portion of the motor of FIGS. 1-5, particularly illustrating the interface between the heat-producing component and the transfer element;

FIG. 4b is an enlarged, partially sectioned view of a portion of the motor of FIGS. 1-5, particularly illustrating the interconnection between the dripshield and the rear endshield;

FIG. 5 is an exploded rear perspective view of the motor of FIGS. 1-4;

FIG. 5a is an exploded perspective view of the rear endshield and controller of the motor of FIGS. 1-5;

FIG. 6 is an exploded front perspective view of the motor of FIGS. 1-5;

FIG. 7 is a rear perspective view of the rear endshield of the motor of FIGS. 1-6;

FIG. 8 is a front perspective view of the rear endshield of FIG. 7;

FIG. 9 is a side partially sectioned view of the rear endshield of FIGS. 7 and 8;

FIG. 10 is a front perspective view of the dripshield of the motor of FIGS. 1-6;

FIG. 11 is a rear perspective view of the dripshield of FIG. 10;

FIG. 12 is an exploded cross-sectional top, rear perspective view of the dripshield and rear endshield of FIGS. 1-6, particularly illustrating the means of interconnection of the dripshield and the rear endshield;

FIG. 13 is an exploded cross-sectional bottom, rear perspective view of the dripshield and rear endshield portions of FIG. 12;

FIG. 14 is an exploded cross-sectional bottom, front perspective view of the dripshield and rear endshield portions of FIGS. 12 and 13;

FIG. 15 is a rear perspective view of a portion of the motor of FIGS. 1-6, with part of the dripshield being sectioned away to illustrate the wire-protecting components of the dripshield and rear endshield; and

FIG. 16 is a rear perspective view of a portion of the motor of FIGS. 1-6, with the dripshield being wholly removed to illustrate the wire tie-off structure and the wire tie associated therewith.

The drawing figures do not limit the present invention to the specific embodiments disclosed and described herein. The drawings are not necessarily to scale, emphasis instead being placed upon clearly illustrating the principles of the preferred embodiments.

Furthermore, directional references (e.g., top, bottom, front, back, up, down, etc.) are used herein solely for the sake of convenience and should be understood only in relation to each other. For instance, a component might in practice be oriented such that faces referred to as “top” and “bottom” are sideways, angled, inverted, etc. relative to the chosen frame of reference.

It is also noted that, as used herein, the terms axial, axially, and variations thereof mean the defined element has at least some directional component along or parallel to the axis. These terms should not be limited to mean that the element extends only or purely along or parallel to the axis. For example, the element may be oriented at a forty-five degree (45°) angle relative to the axis but, because the element extends at least in part along the axis, it should still be considered axial. Similarly, the terms radial, radially, and variations thereof shall be interpreted to mean the element has at least some directional component in the radial direction relative to the axis.

It is further noted that the term annular shall be interpreted to mean that the referenced object extends around a central opening so as to be generally toroidal or ring-shaped. It is not necessary for the object to be circular, nor does the object have to be continuous. Similarly, the term toroidal shall not be interpreted to mean that the object must be circular or continuous.

### DETAILED DESCRIPTION OF THE PREFERRED EMBODIMENTS

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

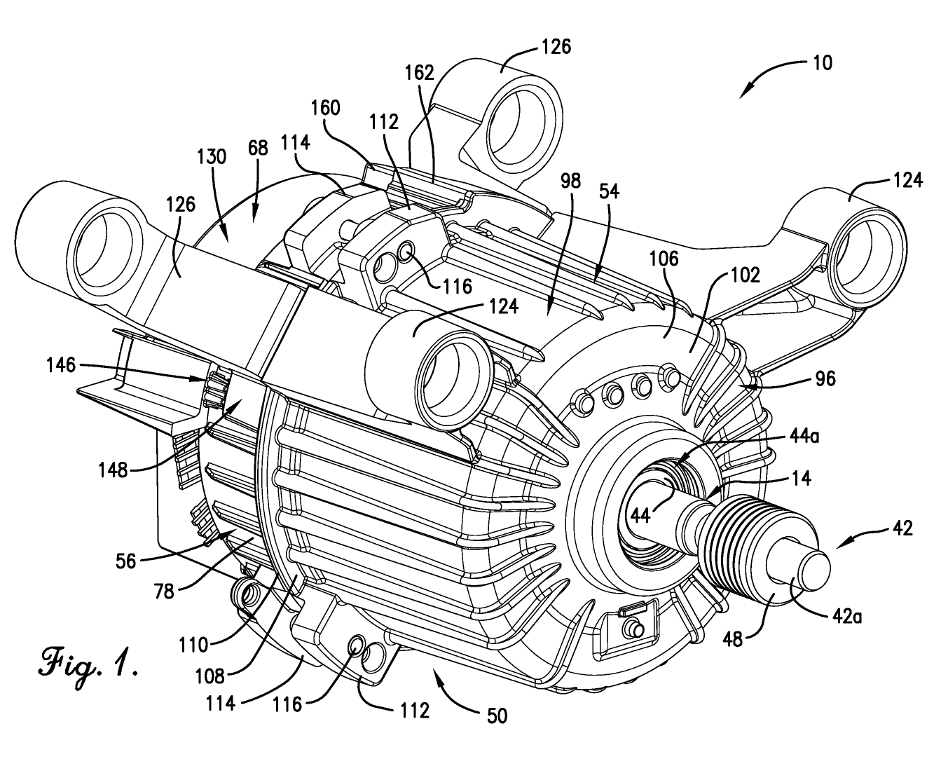

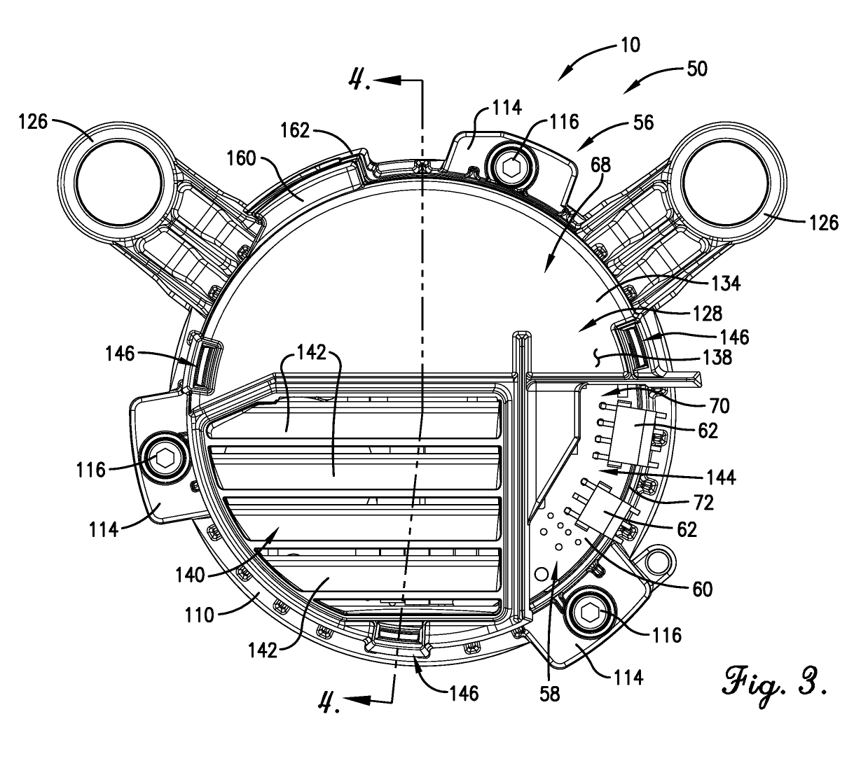

With initial reference to FIGS. 1-6, a motor 10 is provided. The motor 10 is preferably for use in a machine such as a horizontal axis washing machine. However, it is permissible for the motor to be used in any one or more of a variety of alternate applications.

The motor 10 is preferably a brushless permanent magnet (BPM) motor, although other motor types may be used without departing from the scope of the present invention.

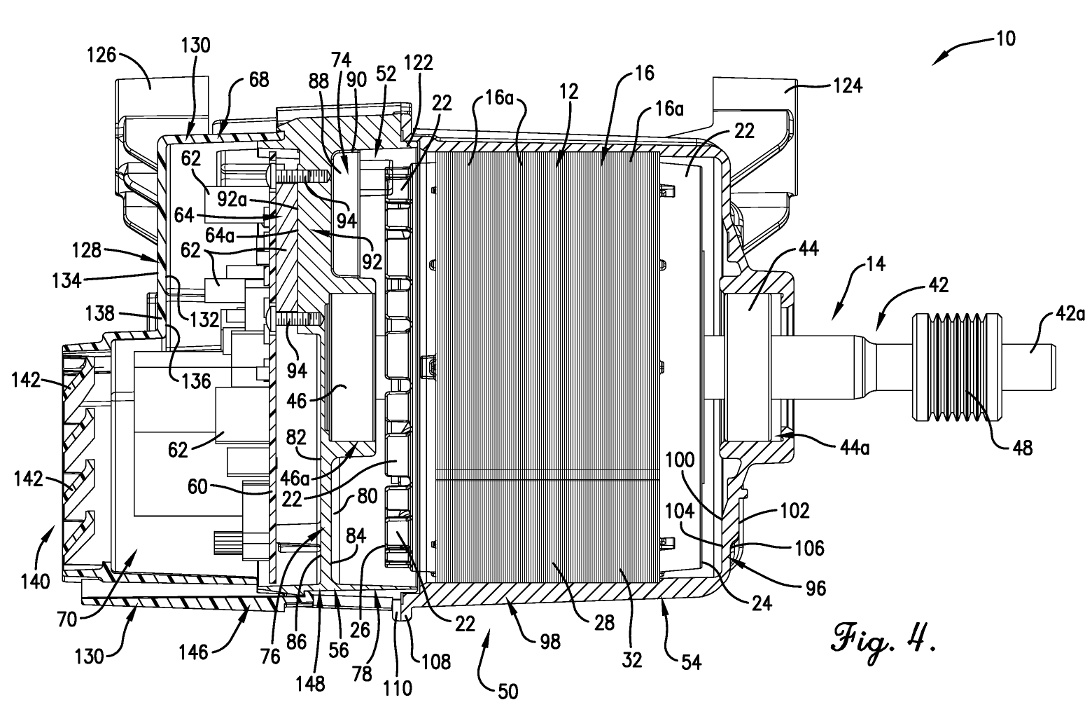

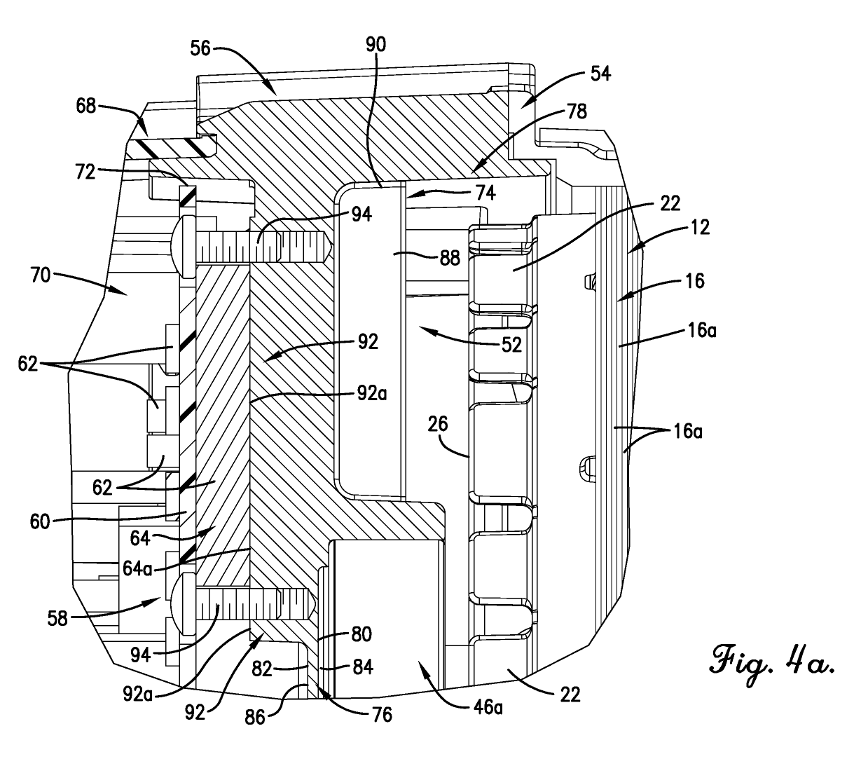

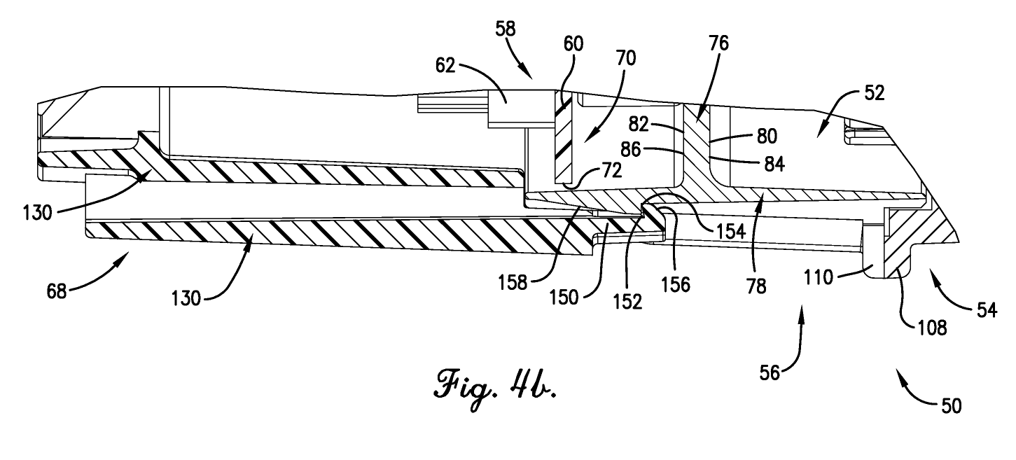

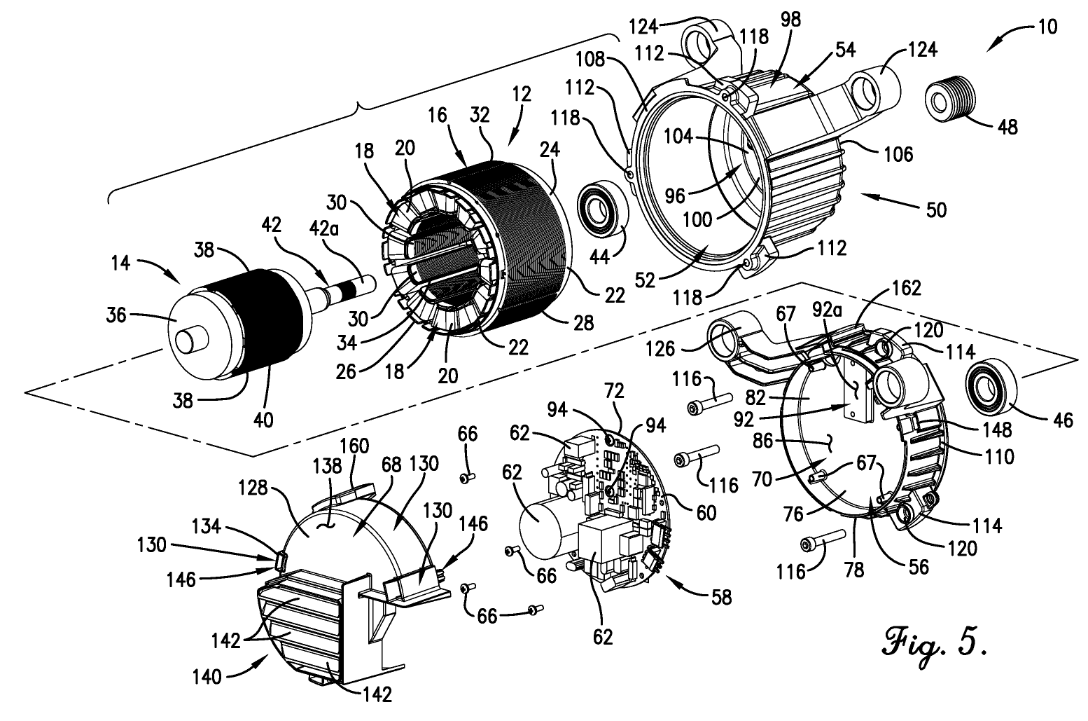

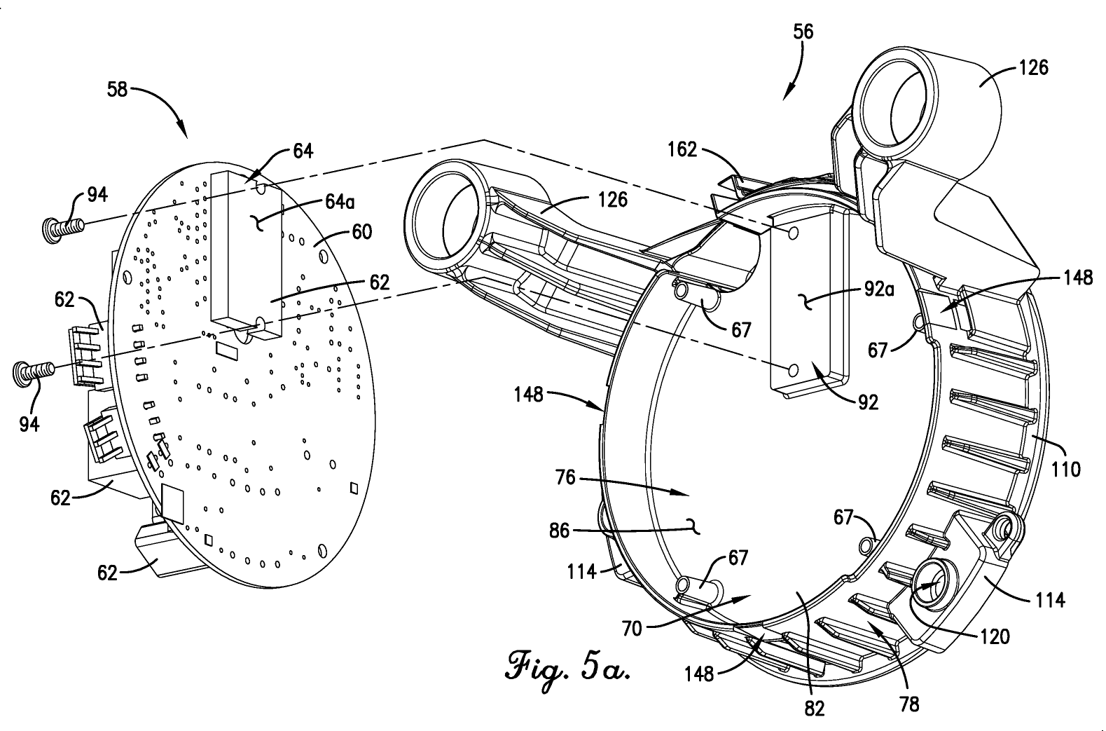

The motor 10 preferably includes a stator 12 and a rotor 14. As best shown in FIG. 5, the stator 12 preferably includes a core 16 and a plurality of coils 18 wound about the core 16. The core 16 is preferably formed of steel (for instance, S85H5 steel) and includes a plurality of laminations 16a, as best shown in FIG. 4. It is permissible, however, for the core to be non-laminated and/or formed of any one any one or more of a variety of materials.

The coils 18 preferably comprise electrically conductive wiring 20, such as copper or aluminum. Any of a variety of electrically conductive materials may be used without departing from the scope of some aspects of the present invention, however.

An electrically insulative covering 22 is preferably provided between the core 16 and the coils 18. The covering 22 preferably comprises a synthetic resin material, but any one or more of a variety of substantially electrically insulative materials may be used without departing from the scope of the present invention. Furthermore, it is permissible for the core to be non-insulated or insulated in a different manner (e.g., via powder-coating or the use of insulative tapes or papers).

The covering 22 preferably presents axially endmost margins 24 and 26 of the stator 12.

In a preferred embodiment, the stator 12 is preferably generally toroidal in form. The core 16 is likewise preferably generally toroidal in form and defines an axis of the stator 12. More particularly, the core 16 preferably includes an annular yoke 28 and a plurality of arcuately spaced apart teeth 30 extending at least generally radially from the yoke 28. The coils 18 are preferably wound about the teeth 30.

The yoke 24 preferably presents a radially outermost margin 32 of the stator 12, while the teeth 30 preferably present a radially innermost margin 34 of the stator 12. As will be discussed in greater detail below, however, it is permissible according to some aspects of the present invention for the yoke to instead present a radially innermost margin of the stator and for the teeth to instead present a radially outermost margin of the stator.

The rotor 14 is preferably rotatable relative to the stator 12 about a rotor axis. Preferably, the axis of the stator 12 is coaxial with that of the rotor 14. However, it is permissible according to some aspects of the present invention for the axes to be non-coaxial.

The rotor 14 preferably includes a core 36 and a plurality of permanent magnets 38. The magnets 38 preferably define a radially outermost margin 40 of the rotor 14.

The motor 10 is preferably an inner rotor motor. That is, the rotor 14 is preferably at least substantially circumscribed by the stator 12 such that a circumferential gap (not shown) is formed between the innermost margin 34 of the stator 12 and the outermost margin 40 of the rotor 14. However, it is permissible according to some aspects of the present invention for the rotor to instead at least substantially circumscribe the stator, with the stator teeth presenting the outermost margin of the stator and the stator yoke presenting the innermost margin of the stator.

In a preferred embodiment, the rotor 14 includes a shaft 42 having a drive end 42a. The rotor 14 is rotatable about an axis. The shaft 42 (and, therefore, the rotor 14) is preferably supported on a pair of bearings 44,46 supported in bearing pockets 44a,46a discussed in greater detail below. The bearings may be of any suitable type.

A sheave 48 is preferably fixed to the drive end 42a to enable interconnection of a belt to be driven by the motor 10. However, alternative mechanisms may be provided to enable the transfer of motor power in accordance with the desired application.

The motor 10 further preferably includes a motor case 50 that presents a motor chamber 52. The stator 12 is preferably located in the motor chamber 50. The motor case 50 is preferably devoid of vent openings so as to present a closed motor design. It is permissible according to some aspects of the present invention, however, for one or more vent openings to be provided in the case.

The case 50 preferably includes a front endshield 54 and a rear endshield 56, both of which will be discussed in greater detail below.

The motor 10 preferably includes a motor controller 58 supported relative to the motor case 50. The controller 58 preferably includes a printed circuit board 60 and a plurality of electronics components 62 mounted thereon. The electronics components 62 include at least one heat-producing component 64 presenting a contact surface 64a. In a preferred embodiment, the heat-producing component 64 is a power supply module.

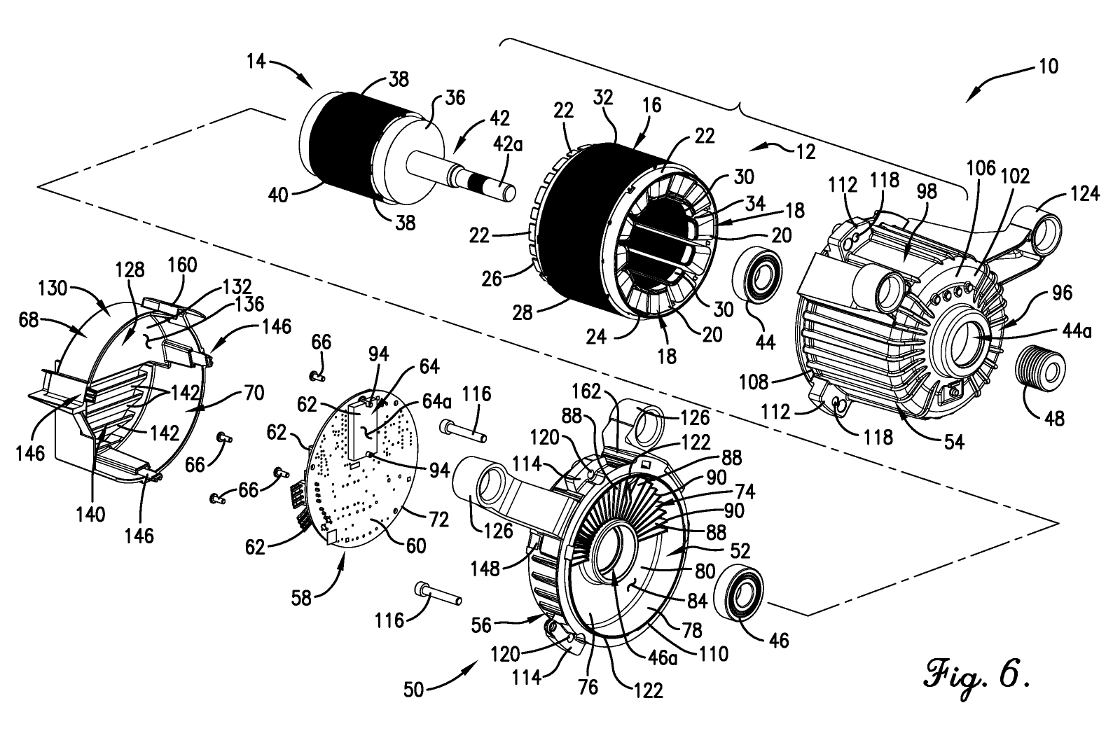

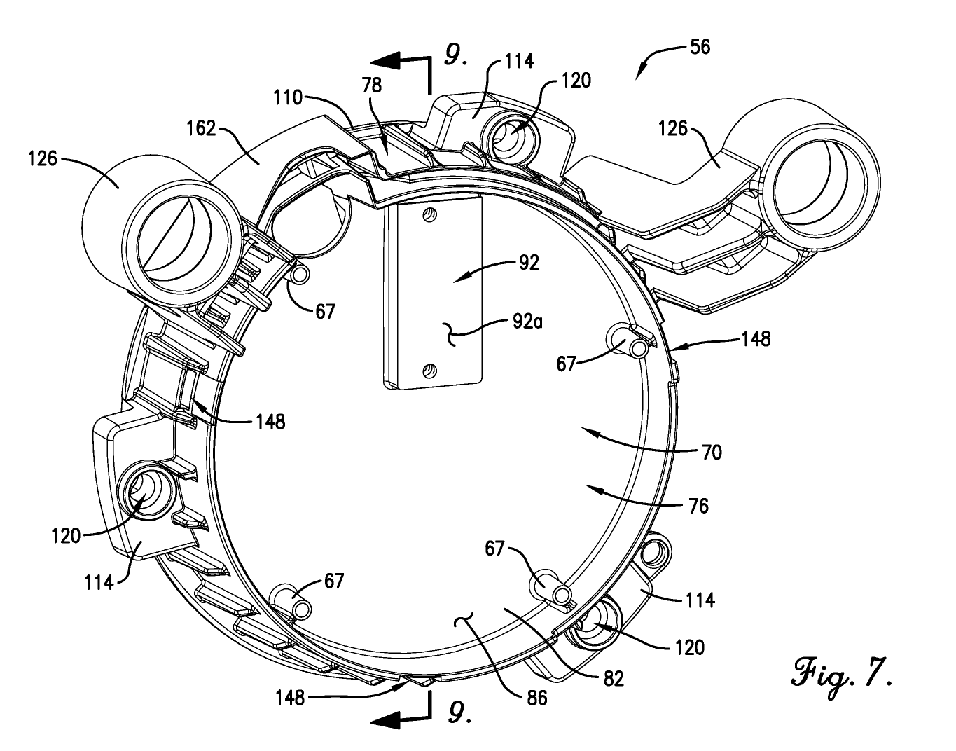

As best shown in FIGS. 5 and 6, the controller 58 is preferably mounted adjacent the external side 82 of the rear endshield 56. Most preferably, the controller 58 is mounted directly on the rear endshield 56 of the motor case 50 via a plurality of evenly arcuately spaced apart screws 66 that are received in corresponding bosses 67 formed in the rear endshield 56. However, alternative mounting means, including but not limited to the use of latches, adhesives, and/or alternate fasteners, are permissible.

A dripshield 68 is preferably secured to the motor case 50 and cooperates therewith to define a controller chamber 70 in which the controller 58 is at least substantially located. More particularly, the dripshield 68 is preferably a snap-on dripshield 68 secured to the rear endshield 56. The dripshield 68 will be discussed in greater detail below.

Preferably, the controller 58 has a circumferential outer margin 72 defined by the printed circuit board 60. The outermost margin 32 of the stator and the outer margin 72 of the controller 48 are preferably concentric and have approximately the same shape and size so as to be axially aligned. Such an arrangement enables the dripshield 68 and the motor case 50 to have similar radial dimensions. It is permissible according to some aspects of the present invention, however, for the controller margin to be non-circular and/or to have a different shape and/or size than the outermost margin of the stator. The dripshield and motor case might thus have similar non-circular cross-sectional shapes and/or have substantially different generally radial dimensions. Furthermore, the stator and the controller might be offset from one another such that their outer margins are axially misaligned.

In a preferred embodiment, the heat-producing component 64 of the controller 58 is positioned external of the motor chamber 52. More particularly, the heat-producing component 64 is preferably positioned in the controller chamber 70. It is permissible according to some aspects of the present invention, however, for the heat-producing component to be positioned in an alternative position while remaining external to the motor chamber or to instead be positioned in whole or in part inside the motor chamber.

The motor 10 preferably includes a heat sink 74 located within the motor chamber 52 and, as will be discussed in greater detail below, thermally coupled with the heat-producing component 64. More particularly, the rear endshield 56 preferably includes a generally radially extending end wall 76 and a generally circumferentially extending side wall 78 extending axially from the end wall 76. The end wall 76 presents internal and external sides 80 and 82, respectively. The internal side 80 at least in part defines an internal margin 84 of the rear endshield 56, while the external side 82 at least in part defines an external margin 86 of the rear endshield 56. The internal margin 84 at least in part defines the motor chamber 52, while the external margin 86 at least in part defines the controller chamber 70. The heat sink 74 is preferably located along the internal margin 76. However, alternative placement is possible within the ambit of some aspects of the present invention.

Preferably, the heat sink 74 comprises a plurality of fins 88 projecting axially from the internal side 80 of the end wall 76 and extending radially relative to the axis of the rotor 14. Each fin 88 preferably presents a radially outermost end 90, with the ends 90 preferably being evenly arcuately spaced apart. It is permissible according to some aspects of the present invention, however, for the heat sink to be alternately configured. The heat sink might not include fins, for instance, or it might include non-radially extending fins (e.g., parallel fins). The fins might also be irregularly spaced apart or spaced apart in a graduated manner.

Although the term “heat sink” may in some instances be broadly applied to any heat-dissipating structure, “heat sink” as used herein should be understood to refer only to a finned structure as described above.

In a preferred embodiment, the heat sink 74 is integrally formed with the rear endshield 56. However, it is permissible without departing from the scope of some aspects of the present invention for a non-integral heat sink to be provided. The heat sink might be attached to the rear endshield via adhesives, welding, discrete fasteners, and/or latches, for instance.

As noted previously, the motor controller 58 is preferably mounted on the rear endshield 56 via a plurality of evenly arcuately spaced apart screws 66 that are received in corresponding bosses 67 formed in the rear endshield 56. Such bosses 67 are preferably formed on the end wall 76 and in part define the external margin 86 of the rear endshield 56, such that the controller 58 is mounted to the external margin 86 of the rear endshield 56.

As also noted previously, the heat sink 74 is preferably thermally coupled with the heat-producing component 64. More particularly, the rear endshield 56 preferably includes a transfer element 92 configured to transfer heat directly from the heat-producing component 64 to the heat sink 74. Such coupling is preferably through contact between a heat-producing component contact surface 64a of the heat-producing component 64 and a transfer element contact surface 92a of the transfer element 92. Thermal grease may be interposed between the heat-producing component contact surface 64a and the transfer element contact surface 92a. Although the contact surfaces 64a and 92a are configured to directly contact one another, small inadvertent gaps or spaces might be defined therebetween as a result of manufacturing limitations, damage to either surface, etc. The thermal grease is provided to maximize the direct contact, and therefore thermal connection, between the heat-producing component 64 and the transfer element 92. Alternative and/or additional highly thermally conductive materials (such as films, tapes, adhesives, etc.) may be placed between the contact surfaces 61a and 92a.

In a preferred embodiment, as illustrated, the transfer element 92 projects axially toward the controller 58 and is part of the end wall 76.

The transfer element contact surface 92a and the heat-producing component contact surface 64a are preferably at least substantially congruent in shape. That is, in a preferred embodiment, both the transfer element contact surface 92a and the heat-producing component contact surface 64a are rectangular and of similar size. Such an approach increases the efficiency with which heat is transferred from the heat-producing component 64 to the transfer element 92 and, in turn, to the heat sink 74. It is permissible according to some aspects of the present invention, however, for the shapes and/or sizes of the transfer element contact surface 92a and the heat-producing component contact surface 64a to be substantially dissimilar.

Although the transfer element 92 is preferably an integral part of the end wall 76, it is permissible according to some aspects of the present invention for the transfer element to be a discrete structure attached to the end wall via adhesives, welding, discrete fasteners, latches, and/or other means known in the art.

As best shown in FIGS. 4 and 4a, the board 60 and, more particularly, the heat-producing component 64, is preferably secured directly to the transfer element 92 via a pair of screws 94. Such screws may be eliminated without departing from the scope of the present invention, however, or they may be replaced or supplemented by other securement means including but not limited to adhesives, latches, and alternative discrete fasteners. Regardless of specific means, however, it is preferable that the transfer element 92 and the heat-producing component 64 be fixed relative to each other in a manner conducive toward efficient transfer of heat therebetween.

The front endshield 54 preferably includes a generally radially extending end wall 96 and a generally circumferentially extending side wall 98 extending axially from the end wall 96. The end wall 96 presents internal and external sides 100 and 102, respectively. The internal side 100 at least in part defines an internal margin 104 of the front endshield 54, while the external side 102 at least in part defines an external margin 106 of the front endshield 54. The internal margin 104 at least in part defines the motor chamber 52, while the external margin 106 is exposed to the environment. Thus, the internal margins 84 and 104 of the rear and front endshields 56 and 54, respectively, cooperatively define the motor chamber 52.

The end walls 96 and 76 preferably define respective ones of the previously discussed bearing pockets 44a and 46a.

Each of the front and rear endshields 54,56 preferably includes a respective substantially continuous circumferential flange 108 or 110 extending radially outwardly from the respective side wall 98,78. The flange 108 of the front endshield 54 is preferably positioned rearwardly opposite the end wall 96, while the flange 110 of the rear endshield 56 is preferably positioned forwardly opposite the end wall 76. The flanges 108,110 preferably abut each other, such that at least substantially continuous contact is made between the front and rear endshields 54,56. Thermal grease or another highly heat-conductive insert may be interposed between the flanges 108,110. Thus, the entirety of the motor case 50, not just the heat sink 74, preferably aids in dissipation of heat from the heat-producing component 64.

Preferably, the front and rear endshields 54,56 are formed of metal. For instance, in a preferred embodiment, the endshields 54 and 56 are aluminum castings.

It is permissible according to some aspects of the present invention, however, for the flanges to be substantially discontinuous, non-circumferential, and/or non-contacting along some or all of their lengths. Furthermore, such flanges may be eliminated entirely.

In a preferred embodiment, the front and rear endshields 54,56 each include a plurality of respective evenly arcuately spaced apart bosses 112 or 114 extending radially outwardly relative to the respective side walls 98,78. The bosses 112 are preferably positioned adjacent the flange 108, while the bosses 114 are preferably positioned axially centrally along the side wall 78. A plurality of fasteners 116, each preferably comprising a nut and bolt, preferably extend through corresponding fastener-receiving openings 118,120 in the bosses 112,114. The fasteners 116 secure the front and rear endshields 54, 56 to each other, preferably ensuring the abutment of the flanges 108,110 and the closing of the motor case 50 such that, as noted previously, the motor 10 is a closed motor. It is permissible according to some aspects of the present invention, however for the endshields to be secured to each other by additional or alternative means including but not limited to latches, screws, or adhesives. Furthermore, variations on the preferred boss configurations might occur within the ambit of the present invention. Uneven arcuate spacing is permissible according to some aspects of the present invention, for instance, or the bosses might be positioned in alternate axial positions.

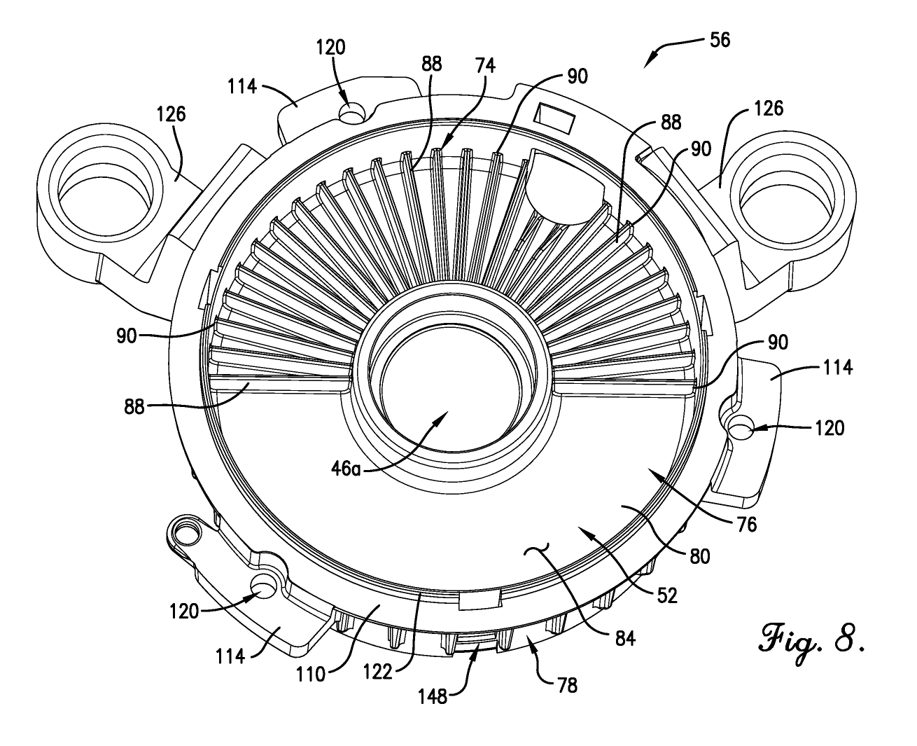

Additional securement of the front and rear endshields 54,56 to each other is preferably provided by the overlapping engagement of portions of the side walls 98 and 78. More particularly, as best shown in FIGS. 6, 8, and 9, the side wall 78 of the rear endshield 56 preferably includes a circumferential, axially extending constricted region 122 that slides inside the front endshield 54 to interface with the side wall 98 of the front endshield 54. That is, a rearward portion of the front endshield 54 overlies the constricted region 122 of the rear endshield 56, providing further protection against ingress of contaminants into the motor chamber 52. Such additional securement means may be eliminated entirely, however, without departing from the scope of the present invention. Alternatively, the constricted region might be configured in a different manner or provided instead on the front endshield.

In a preferred embodiment, each of the front and rear endshields 54,56 includes a pair of mounting arms 124,126 for mounting of the motor 10 in or on a machine. Any of a variety of mounting mechanisms known in the art may be used without departing from the spirit of the present invention, however.

As noted previously, the dripshield 68 is preferably secured to the motor case 50 and cooperates therewith to define the controller chamber 70. The dripshield 78 preferably includes a generally radially extending end wall 128 and a generally circumferentially extending side wall 130 extending axially from the end wall 128. As discussed in more detail below, the side wall 130 is preferably discontinuous. The end wall 128 preferably presents internal and external sides 132 and 134, respectively. The internal side 132 at least in part defines an internal margin 136 of the dripshield 78, while the external side 134 at least in part defines an external margin 138 of the dripshield 78. The internal margin 136 at least in part defines the controller chamber 70, while the external margin 138 is exposed to the environment

A baffle 140 comprising a plurality of louvers 142 is preferably formed on the end wall 128. The louvers 142 are preferably configured to deflect moisture and/or other environmental contaminants to prevent or deter ingress thereof into to the controller chamber 70. In a preferred embodiment, the louvers 142 are arranged in parallel and are evenly spaced apart. Uneven spacing and/or non-parallel arrangements fall within the scope of the present invention, however.

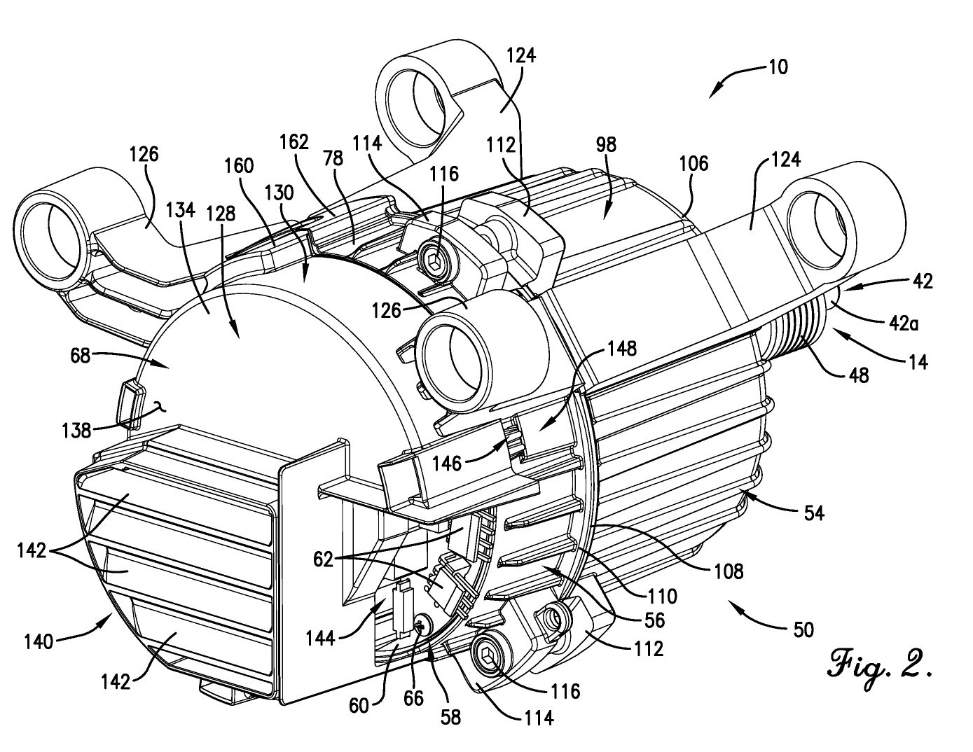

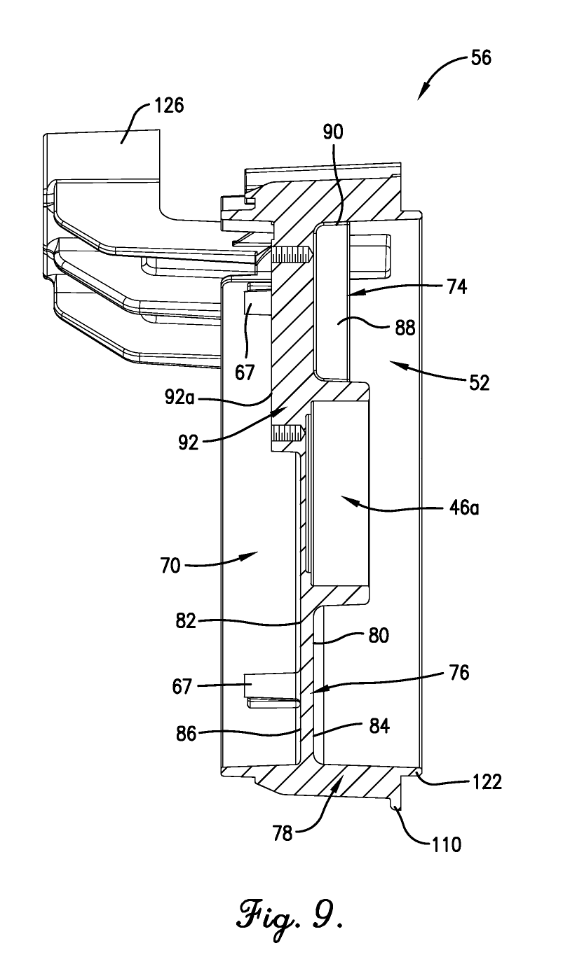

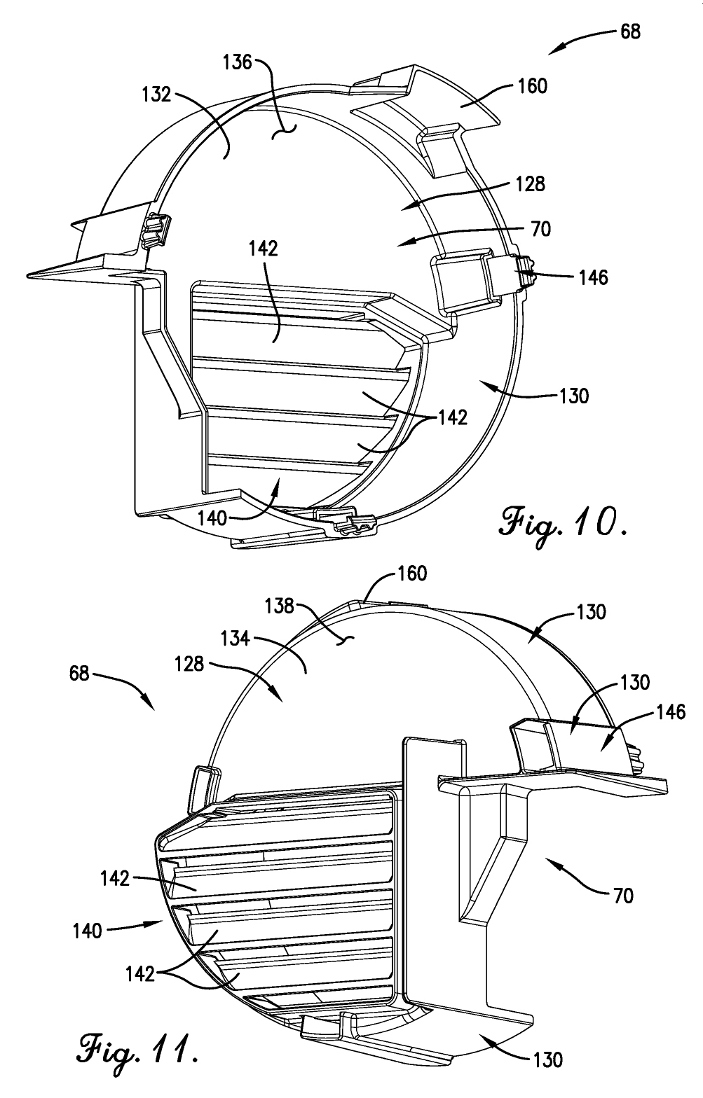

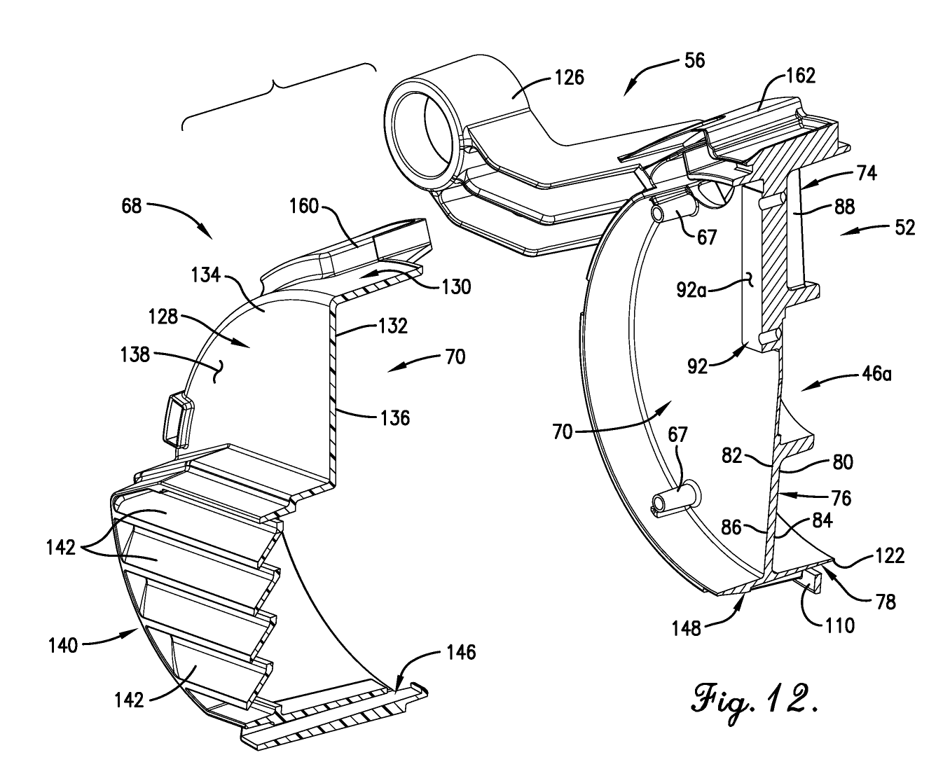

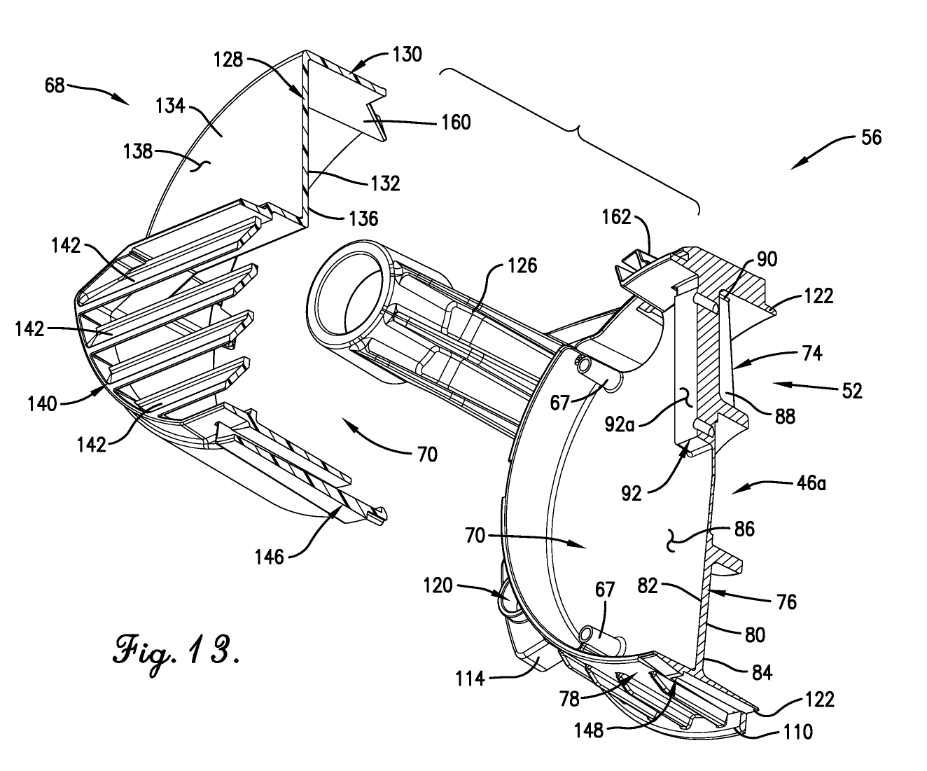

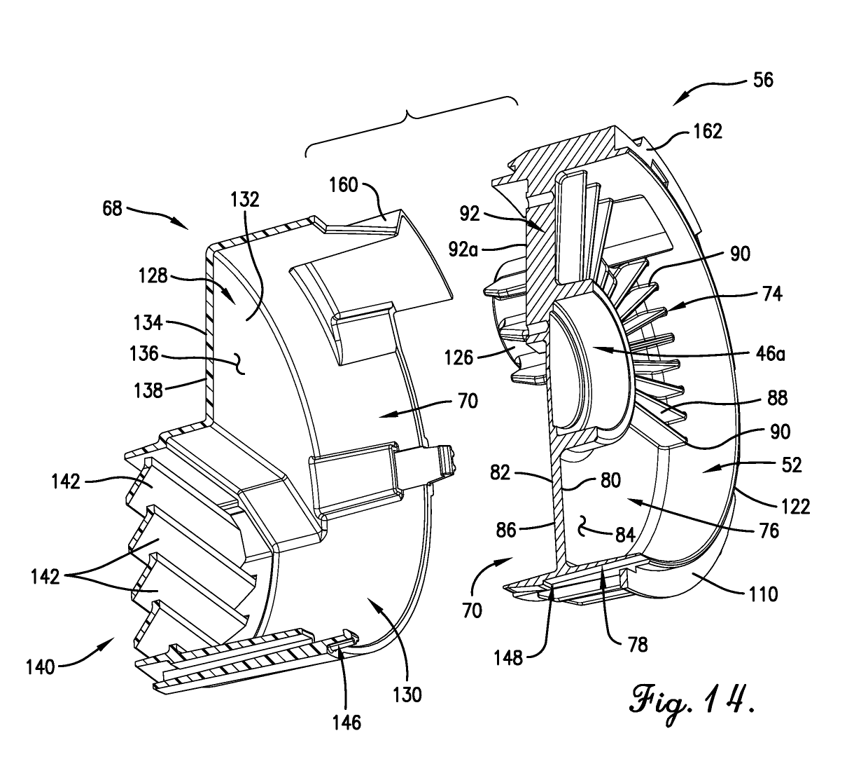

As best shown in FIGS. 2, 3, 10, and 11, the dripshield 78 preferably defines an access opening 144 enabling access to at least some of the electronics components 62 of the controller 58. The side wall 130 is thus discontinuous in a preferred embodiment. Such an opening maybe omitted without departing from the cope of the present invention, however.

In a preferred embodiment, the dripshield 68 and the rear endshield 56 present complementary pairs of latch components, with each pair of latch components including a dripshield latch component 146 and an endshield latch component (or, more broadly, a motor case latch component) 148. Each pair of latch components 146,148 is preferably automatically interlocked to secure the dripshield 68 on the rear endshield 56 or, more broadly, on the motor case 50.

As best shown in FIG. 4b, the dripshield latch component 146 preferably includes a generally axially extending, resiliently deflectable arm 150 associated with the side wall 130. The arm 150 preferably projects axially so as to be radially deflectable. The dripshield latch component 146 further preferably includes a generally radially extending shoulder 152 projecting radially inwardly from the arm 150.

As also best shown in FIG. 4b, the endshield latch component 148 preferably includes a generally radially extending shoulder 154 projecting radially outwardly from the side wall 78 and facing opposite the shoulder 152 of the dripshield latch component 146.

The shoulders 152 and 154 preferably engage each other to restrict relative axial movement between the dripshield 68 and the rear endshield 56 or, more broadly, the motor case 50.

In a preferred embodiment, the latch components 146,148 include respective complementary cam surfaces 156,158 configured to guide the deflection of the arm 150. Thus, sufficient relative axial shifting of the rear endshield 56 and the dripshield 68 results in automatic engagement or interlocking of the latch components 146,148.

Although the above-described latch components are preferred, it is permissible according to some aspects of the present invention for the dripshield to be connected by means distinct from automatically engaging latches or in addition to automatically engaging latches. For instance, screws or other fasteners might be provided, although it is preferred that the motor be devoid of non-integral fasteners for attachment of the dripshield. Furthermore, alternatively configured latches might be provided. The endshield latch component might include a resiliently deflectable arm, for instance, and/or the dripshield latch component might be devoid of an arm. The latch components might also be alternatively positioned. For instance, the endshield latch components might alternatively be associated with the end wall of the rear endshield instead of the side wall of the rear endshield, and/or the latch components might alternatively be associated with the front endshield instead of the rear endshield.

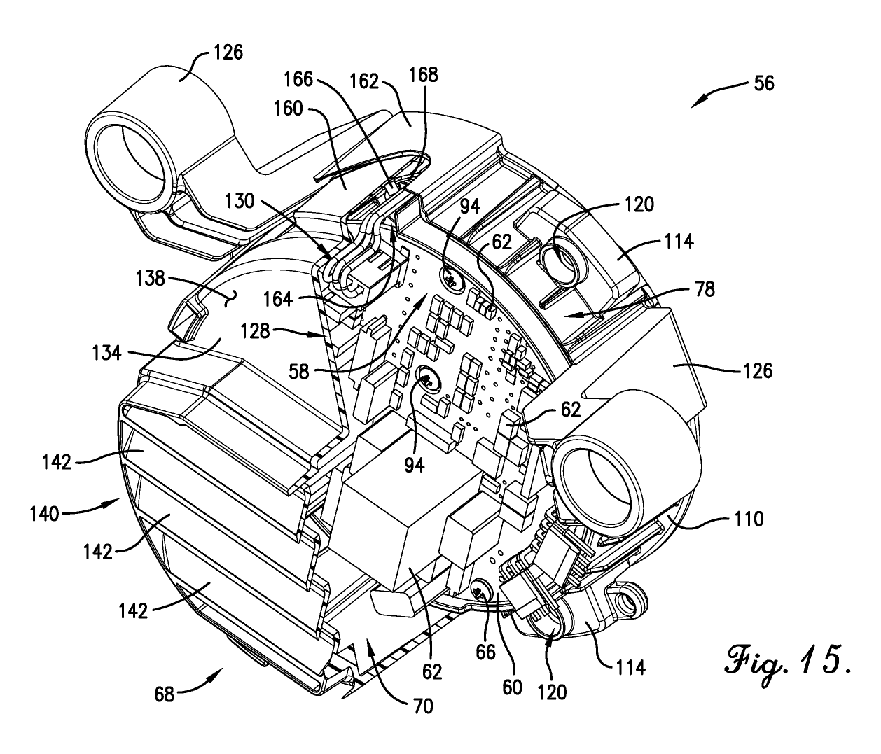

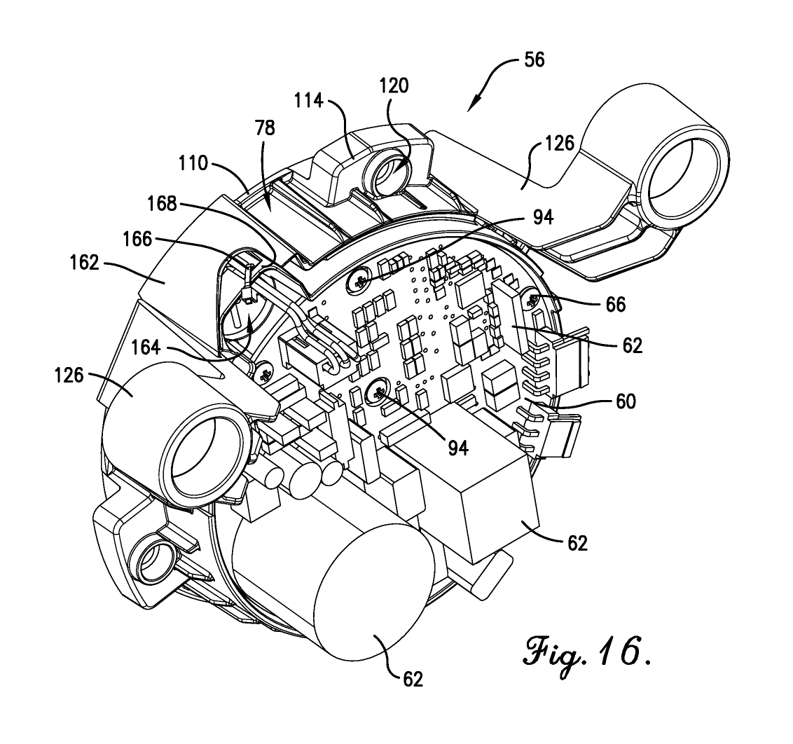

As best shown in FIGS. 15 and 16, the dripshield 68 and the rear endshield 56 preferably present a complementary pair of wire-protecting components including a dripshield wire-protecting component 160 and an endshield wire-protecting component (or, more broadly, a motor case wire-protecting component) 162. The wire-protecting components 160 and 162 cooperatively define a wiring passageway 164 fluidly interconnecting the controller chamber 70 and the motor chamber 52. Wiring 20 extends from the controller 58 in the controller chamber 70, through the wiring passageway 164, to the stator 12 in the motor chamber 52.

Preferably, the wiring 20 is secured in the wiring passageway 164 by a wire tie 166 that engages a tie-off structure 168 formed as part of the endshield wire-protecting component 162.

Alternative means by which wiring may extend between the controller and the stator are permissible without departing from some aspects of the present invention, however.

Although the above description presents features of preferred embodiments of the present invention, other preferred embodiments may also be created in keeping with the principles of the invention. Furthermore, these other preferred embodiments may in some instances be realized through a combination of features compatible for use together despite having been presented independently in the above description.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention set forth in the following claims.

What is claimed is:

1. An electric motor comprising:
a stator;
a rotor rotatable relative to the stator about a rotor axis;
a motor case presenting a motor chamber in which the stator is located;
a motor controller supported relative to the motor case, with the motor controller including a heat-producing component external of the motor chamber; and
a heat sink thermally coupled with the heat-producing component of the motor controller, said heat sink being located within the motor chamber.

2. The electric motor as claimed in claim 1,
said motor case including a rear endshield that presents internal and external margins,
said internal margin at least in part defining the motor chamber,
said heat sink being located along the internal margin of the rear endshield.

3. The electric motor as claimed in claim 2,
said heat sink being integrally formed with the rear endshield.

4. The electric motor as claimed in claim 3,
said motor case being devoid of vent openings so as to present a closed motor design.

5. The electric motor as claimed in claim 3,
said motor controller being mounted to the external margin of the rear endshield.

6. The electric motor as claimed in claim 5,
said heat-producing component of the motor controller contacting the external margin of the rear endshield.

7. The electric motor as claimed in claim 2,
said rear endshield including a generally radially extending end wall,
said end wall presenting an internal side which defines at least part of the internal margin of the rear endshield,
said end wall presenting an external side which defines at least part of the external margin of the rear endshield.

8. The electric motor as claimed in claim 7,
said heat sink including a plurality of fins projecting axially from the internal side of the end wall.

9. The electric motor as claimed in claim 8,
each of said fins extending radially relative to the rotor axis.

10. The electric motor as claimed in claim 9,
said fins presenting radially outermost ends which are arcuately spaced apart,
said radially outermost ends being spaced evenly.

11. The electric motor as claimed in claim 8,
said heat-producing component of the motor controller contacting the external side of the end wall.

12. The electric motor as claimed in claim 2,
said motor case including a second endshield, which cooperates with the rear endshield to at least substantially define the motor chamber.

13. The electric motor as claimed in claim 12,
said endshields each being cast of metal,
said endshields being in direct contact with one another,
said endshields being devoid of vent openings so as to present a closed motor design.

14. The electric motor as claimed in claim 2,
said rear endshield including a transfer element configured to transfer heat from the heat-producing component to the heat sink.

15. The electric motor as claimed in claim 14,
said transfer element presenting a transfer element contact surface,
said heat-producing component presenting a heat-producing component contact surface that contacts the transfer element contact surface.

16. The electric motor as claimed in claim 15,
said heat sink being integrally formed with the rear endshield.

17. The electric motor as claimed in claim 15,
said contact surfaces being at least substantially congruent.

18. The electric motor as claimed in claim 17,
said motor including thermal grease interposed between the contact surfaces.

19. The electric motor as claimed in claim 15,
said heat-producing component being secured to the transfer element by at least one fastener.

20. The electric motor as claimed in claim 1,
said motor including a snap-on dripshield that cooperates with the motor case to define a controller chamber in which the controller is at least substantially located,
said dripshield and motor case including complementary dripshield and case latch components,
each of said dripshield latch components automatically interlocking with a corresponding one of said case latch components so as to secure the dripshield on the motor case.

21. An electric motor comprising:
a stator;
a rotor rotatable relative to the stator about a rotor axis;
a motor case presenting a motor chamber in which the stator is located;
a motor controller located external of the motor chamber; and
a snap-on dripshield cooperating with the motor case to define a controller chamber in which the controller is at least substantially located,
said dripshield and motor case presenting complementary pairs of latch components, with each pair of latch components including a dripshield latch component and a case latch component,
each pair of latch components being automatically interlocked to secure the dripshield on the motor case.

22. The electric motor as claimed in claim 21,
each pair of latch components presenting oppositely facing, generally radially extending shoulders, with engagement of the shoulders restricting relative axial movement between the dripshield and the motor case.

23. The electric motor as claimed in claim 22,
at least one of said latch components of each pair of latch components including a generally axially extending arm, with the shoulder of said at least one of the latch components projecting from the arm.

24. The electric motor as claimed in claim 23,
said arm being resiliently deflectable.

25. The electric motor as claimed in claim 24,
each of said dripshield latch components and each of said endshield latch components defining complementary cam surfaces configured to guide the deflection of the corresponding arm.

26. The electric motor as claimed in claim 23,
each of said dripshield latch components including one of the generally axially extending arms.

27. The electric motor as claimed in claim 21,
said motor case including an endshield that presents internal and external margins,
said internal margin at least in part defining the motor chamber,
said motor controller being mounted adjacent the external margin,
each of said case latch components being integrally formed with the endshield.

28. The electric motor as claimed in claim 21,
said motor controller including a heat-producing component external of the motor chamber,
said motor further comprising a heat sink thermally coupled with the heat-producing component of the motor controller,
said heat sink being located within the motor chamber,
said heat sink being integrally formed with the endshield.

29. The electric motor as claimed in claim 21,
said motor case including a generally axially extending, generally circumferential motor case side wall,
said dripshield including a generally axially extending, generally circumferentially extending dripshield side wall,
said motor case latch components associated with from the motor case side wall,
said dripshield latch components associated with the dripshield side wall.

30. The electric motor as claimed in claim 21,
said dripshield and motor case presenting a complementary pair of wire-protecting components including a dripshield wire-protecting component and a case wire-protecting component,
said wire-protecting components defining a wiring passageway fluidly interconnecting the controller chamber and the motor chamber,
said motor including wiring extending from the controller to the motor chamber through the wiring passageway.
